(19) United States
(12) Patent Application Publication
(10) Pub. No.: US 2010/0084157 A1
(43) Pub. Date: Apr. 8, 2010

(54) DIGITAL AUDIO VIDEO CABLE

(75) Inventor: Chang-Pin Wang, Yung-Ho City (TW)

Correspondence Address: SURE-FIRE ELECTRICAL CORPORATION, 2F-4, NO. 148, SEC. 4, CHUNG HSIAD E. ROAD, TAIPEI, TW

(73) Assignee: SURE-FIRE ELECTRICAL CORPORATION, Hsinchuang City (TW)

(21) Appl. No.: 12/244,777

(22) Filed: Oct. 3, 2008

(51) Int. Cl. H01B 7/17

(52) U.S. Cl. 174/107

(57) ABSTRACT

A low-capacitance, interference-free, stretch-prevention and high tensile strength digital audio video cable practical for a long-distance application is disclosed to include an electrical strand formed of multiple high-frequency transmission lines and low-frequency transmission wires and a filler, a tin foil layer surrounding the electrical strand, a braided layer surrounding the tin foil layer, and an outer plastic sheath surrounding the braided layer. Each high-frequency transmission line includes multiple high-frequency transmission wires that are equal in length and arranged in parallel, an insulation layer surrounding the high-frequency transmission wires, two shielding layers surrounding the insulation layer, and a grounding wire set in between the two shielding layers in a middle position relative to the high-frequency transmission wires.

### BACKGROUND OF THE INVENTION

1. Field of the Invention

The present invention relates to cables and more particularly, to a digital audio video cable that is electrically connectable with a HDMI connector, avoids the drawbacks of high frequency audio video signal attenuation and extended wire length requirement of a conventional digital audio video cable of twisted wire pair design, and has the characteristics of low capacitance value, extremely low attenuation rate and high transmission stability and reliability.

2. Description of the Related Art

Following fast development of information technology and digital multimedia technology, the living style of people is changed and, many high-tech products, such as DVD, digital versatile disc, HDTV, video phone, video conference system and etc., are being continuously developed for use in the fields of food, clothing, housing, transportation and entertainment to satisfy different use requirements. When compared to conventional techniques, advanced modern audio and video products process audio and video signals by means of digitalization means. Further, subject to requirements for different application fields, different audio and video signal transmission standards have been defined, modified and updated to achieve synchronized, long-distance and high-speed transmission without compression or signal distortion, enabling the user to experience the best in digital audio and video quality and lifelike visual images.

In order to satisfy requirements for different applications, HDMI (High-Definition Multimedia Interface) was developed as the digital interface standard. Through a HDMI connector, a signal cable is connectable to an adapter, set-top box, DVD player, TV game machine, digital TV, PC display screen, integrated amplifier, digital audio system or the like to transmit digital audio and video signals, smoothening signal playout. Further, a signal transmission cable can be a round or flat cable having different signal transmission wires arranged therein, for example, video transmission wires, audio transmission wires, grounding wires, etc. These signal transmission wires are arranged into a strand and, surrounded in proper order by a tin foil layer, a braided layer and an outer insulation layer to avoid interference of electromagnetic waves and noises.

FIG. 5 is a schematic drawing of a conventional digital audio video cable. As illustrated, this digital audio video cable comprises multiple twisted wire pairs. When this digital audio video cable is connected with a HDMI connector for transmitting digital audio and video signals, the limitations of the structure and the material of this twisted wire pair design of digital audio video cable causes the following drawbacks and problems:

1. For a long distance application, the capacitance value in the twisted wire pairs will be relatively increased subject to the length of the cable, affecting high frequency audio and video signal transmission stability, and the interference of external noises will become worse when the transmission distance is relatively increased.

2. Twisting each two wires together forms the twisted wire pairs of the cable. The twisted wire pair design eliminates the “cross-talking” phenomena and enhances the tensile strength of the cable. However, twisting wires into a twisted wire pair relatively extends the signal transmission path and complicates the control of keeping individual wires in equal length, thereby increasing signal attenuation rate and affecting signal transmission stability.

3. Before bonding the twisted wire pairs to respective pins of a HDMI connector, the wires must be untwisted and straightened, complicating the installation process and cost.

Therefore, it is desirable to provide a digital audio video cable that facilitates installation, avoids signal interference, and has low signal attenuation rate and high transmission stability.

### SUMMARY OF THE INVENTION

The present invention has been accomplished under the circumstances in view.

According to one aspect of the present invention, the digital audio video cable comprises an electrical strand formed of a plurality of high-frequency transmission lines, a plurality of low-frequency transmission wires, a tin foil layer surrounding the electrical strand, a braided layer surrounding the tin foil layer and an outer plastic sheath surrounding the braided layer. Further, each high-frequency transmission line comprises a plurality of high-frequency transmission wires arranged in parallel, an insulation layer surrounding the high-frequency transmission wires, and a grounding wire disposed outside said insulation layer in a parallel manner relative to said high-frequency transmission wires. Because the high-frequency transmission wires, grounding wires and low-frequency transmission wires are straightly arranged in parallel and equal in length, it is convenient to bond the wires of the cable to respective pins of a HDMI connector. Further, each high-frequency transmission wire can be formed of a copper covered steel wire to provide a high tensile strength and flexible mechanical property, avoiding noise interference due to variation in cross sectional area when stretched. Alternatively, each high-frequency transmission wire can be formed of a silver-coated copper clad steel wire for long distance application for the advantages of low signal attenuation rate and high stability and reliability.

According to another aspect of the present invention, each high-frequency transmission line further comprises two shielding layers surrounding the insulation layer, and the grounding wire of each high-frequency transmission line is set in between the two shielding layers of the respective high-frequency transmission line in a middle position relative to the associating high-frequency transmission wires. By means of the shielding effect of the shielding layers of the high-frequency transmission lines to shield the respective high-frequency transmission wires and grounding wires against interference, the digital audio video cable is practical for a long distance application (over 20 meters) without causing any rise in capacitance value.

### BRIEF DESCRIPTION OF THE DRAWINGS

FIG. 1 is a cutaway view of a digital audio video cable made according to the present invention.

FIG. 2 is an end view of FIG. 1.

FIG. 3 is an enlarged view of a part of FIG. 1.

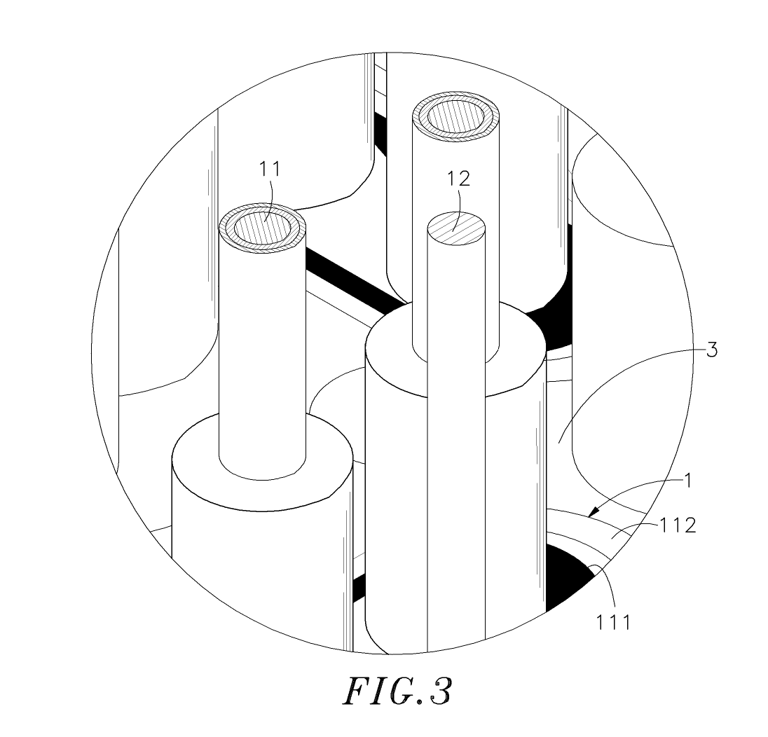

FIG. 4 is an applied view of the present invention, showing the digital audio video cable connected with a HDMI connector.

FIG. 5 is a cutaway view of a digital audio video cable made according to the prior art.

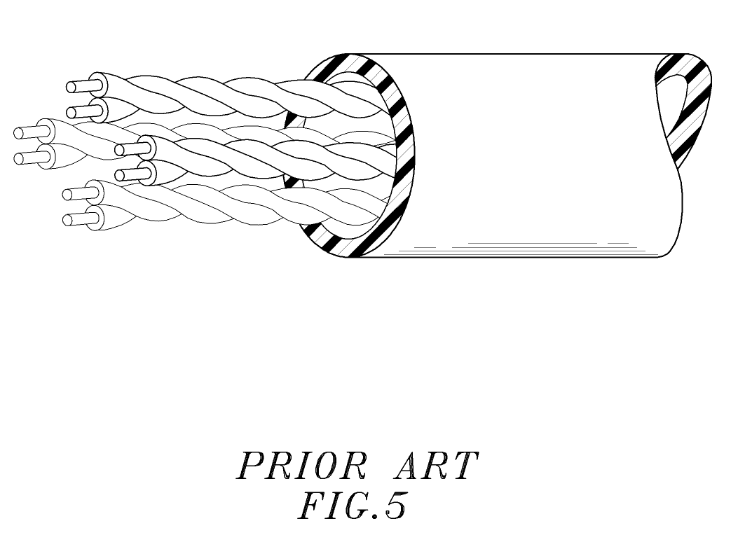

### DETAILED DESCRIPTION OF THE PREFERRED EMBODIMENT

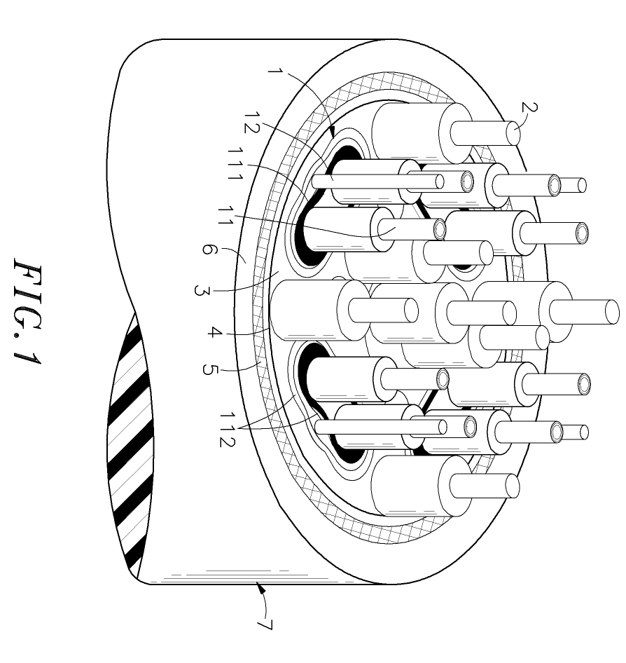

Referring to FIGS. 1˜3, a digital audio video cable 7 in accordance with the present invention is shown comprising a plurality of high-frequency transmission lines 1 and a plurality of low-frequency transmission wires 2.

Each high-frequency transmission line 1 comprises two high-frequency transmission wires 11 that are equal in length and arranged in parallel, an insulation layer 111 surrounding the high-frequency transmission wires 11, two shielding layers 112 that surround the insulation layer 111, and a grounding wire 12 set in between the two shielding layers 112 in a middle position relative to the high-frequency transmission wires 11.

The high-frequency transmission lines 1 and the low-frequency transmission wires 2 are arranged with a filler into an electrical strand 3. The high-frequency transmission wires 11 and grounding wire 12 of each high-frequency transmission line 1 and the low-frequency transmission wires 2 are colored in different colors for quick discrimination. The digital audio video cable 7 further comprises a tin foil layer 4 that surrounds the electrical strand 3, a braided layer 5 that surrounds the tin foil layer 4, and an outer plastic sheath 6 that surrounds the braided layer 5.

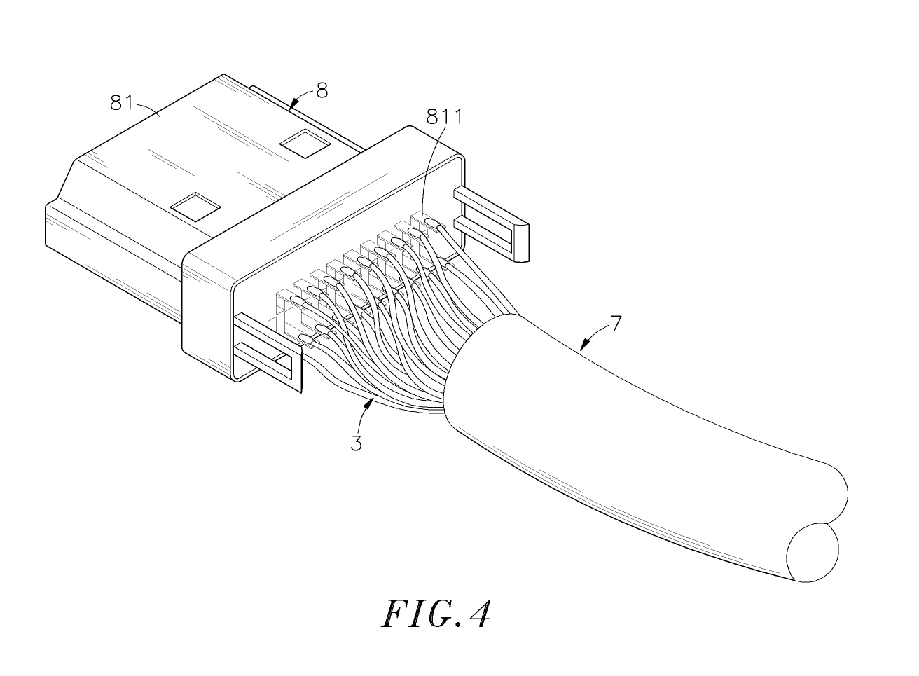

According to the present preferred embodiment, the digital audio video cable 7 is used with a HDMI (High Definition Multimedia Interface) connector 8 (see FIG. 4) for transmitting high frequency audio and video signals. However, the invention is applicable to DisplayPort, DVI (Digital Visual Interface) Further, each high-frequency transmission wires 11 of each high-frequency transmission line 1 can be a silver-coated copper clad steel wire, copper covered steel wire, or any other wire with high tensile strength and high transmission speed. The grounding wires 12 and the low-frequency transmission wires 2 can be respectively prepared from a tinned copper wire, brass wire, or any other flexible metal wire. Further, the insulation layer 111 can be prepared from TPE (thermoplastic elastomer) or PE (polyethylene).

Further, the shielding layers 112 of each high-frequency transmission line 1 are thin transparent layers of light material prepared from, mylar (polyethylene terephthalate polyester film) or cotton paper, and wrapped about the respective high-frequency transmission wires 11 and grounding wire 12 of the respective high-frequency transmission line 1 to provide a good shielding effect, avoiding electromagnetic interference. Further, the braided layer 5 is a tubular braid of brass wires, silver-plated wires or any other metal wires woven subject to a predetermined pattern and surrounding the tin foil layer 4. Further, the outer plastic sheath 6 that surrounds the braided layer 5 can be prepared from PVC (polyvinyl chloride), PE (polyethylene), PET (polyethylene terephthalate) or PP (polypropylene).

When connecting the digital audio video cable 7 to the HDMI connector 8, as shown in FIG. 4, cut off the outer plastic sheath 6, the braided layer 5 and the tin foil layer 4 subject to a selected length, and then strip off the insulation layer 111 and shielding layers 112 of each high-frequency transmission line 1, and then spread out the high-frequency transmission wires 11, the grounding wires 12 and the low-frequency transmission wires 2 for bonding to respective pins 811 of the HDMI connector 8 that has a connection side 81 connectable to an adapter, set-top box, DVD player, TV game machine, digital TV, integrated amplifier, digital audio system or the like for transmitting HDMI signals.

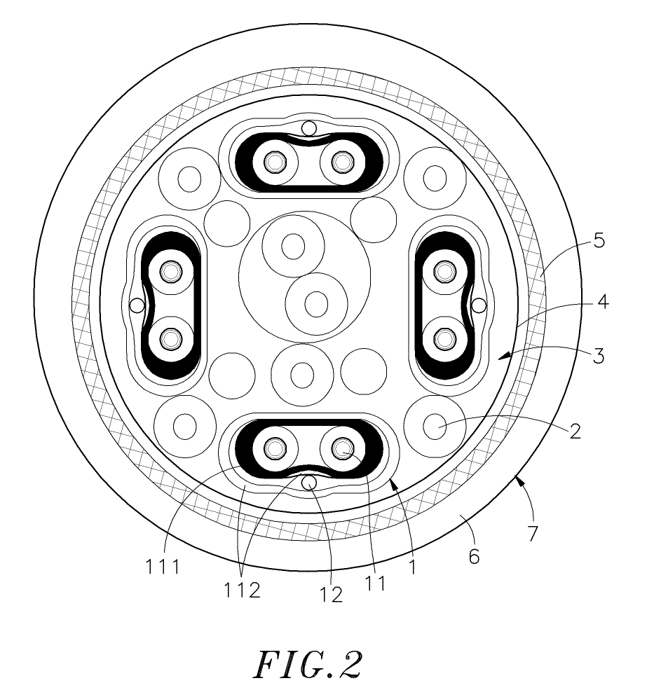

Referring to FIGS. 2˜4 again, as illustrated, the connection side 81 of the HDMI connector 8 is for connection to an external electronic apparatus (not shown), and the pins 811 of the HDMI connector 8 are respectively connected with the high-frequency transmission wires 11, grounding wires 12 and low-frequency transmission wires 2 of the digital audio video cable 7.

By means of the shielding effect of the shielding layers 112 of the high-frequency transmission lines 1 to shield the high-frequency transmission wires 11 and the grounding wires 12 against interference, the digital audio video cable 7 is practical for a long distance application (over 20 meters) without causing any rise in capacitance value. Further, the tin foil layer 4, the braided layer 5 and the outer plastic sheath 6 that surround the electrical strand 3 in proper order enhance signal transmission stability and noise shielding effect of the digital audio video cable 7.

On the other hand, the internal twisted wire pair design of the prior art digital audio video cable has the drawbacks of extended signal transmission path, complicated installation procedure in bonding respective wires to respective pins of a HDMI connector. The digital audio video cable 7 of the invention eliminates the aforesaid drawbacks. Because each high-frequency transmission line 1 has the high-frequency transmission wires 11 straightly arranged in parallel in equal length, saving much material cost and minimizing signal transmission path. During installation, the high-frequency transmission wires 11, the grounding wires 12 and the low-frequency transmission wires 2 can be conveniently bonded to the respective pins at the circuit board of the HDMI connector, saving much labor and time.

Further, to avoid change of cross-sectional area of the high-frequency transmission wires 11 when stretched accidentally by an external force, the high-frequency transmission wires 11 can be formed of a copper covered steel wire for the advantages of high tensile strength and flexible mechanical property.

Further, in order to avoid interference of external noises during signal transmission through a cable, a filter module may be installed in the signal input side of the cable to remove electromagnetic waves and static noises. However, the installation of a filter module shows less effect to a cable having a high impedance and signal attenuation rate. To eliminate this problem, the high-frequency transmission wires 11 can be respectively formed of a silver-coated copper clad steel wire that has the advantages of high surface transmission speed for long distance application, low signal attenuation rate and high transmission stability and reliability.

As stated above, the invention provides a digital audio video cable 7 comprising an electrical strand 3 formed of a plurality of high-frequency transmission lines 1 and a plurality of low-frequency transmission wires 2. Preferably, the digital audio video cable 7 comprises four high-frequency transmission lines 1 for use with a HDMI connector 8 for transmitting high frequency audio and video signals. Further, each high-frequency transmission line 1 comprises two equal high-frequency transmission wires 11 arranged in parallel in equal length, an insulation layer 111 surrounding the high-frequency transmission wires 11, two shielding layers 112 that surround the insulation layer 111, and a grounding wire 12 set in between the two shielding layers 112 in a middle position relative to the high-frequency transmission wires 11. Subject to the aforesaid arrangement, the digital audio video cable 7 has advantages of low capacitance value, low signal attenuation rate and high signal transmission stability and reliability, and is practical for a long distance application (over 20 meters) without causing any rise in capacitance value.

In general, the invention has the following features and advantages:

1. Each high-frequency transmission line 1 of the digital audio video cable 7 has two high-frequency transmission wires 11 straightly arranged in parallel in equal length, facilitating installation and saving much material cost and minimizing signal transmission path.

2. The high-frequency transmission wires 11 of each high-frequency transmission line 1 can be respectively formed of a copper covered steel wire for the advantages of high tensile strength and flexible mechanical property. Therefore, stretching the high-frequency transmission lines 1 accidentally by an external force does not cause the high-frequency transmission wires 11 to change their cross-sectional area, assuring low signal attenuation rate and high signal transmission stability and reliability.

3. When the digital audio video cable 7 is used for a long distance application (over 20 M), the internal shielding layers 112 of each high-frequency transmission line 1 that surround the respective high-frequency transmission wires 11 and grounding wire 12 provide an excellent shielding effect against electromagnetic interference, without causing any rise in capacitance value. Further, the tin foil layer 4, the braided layer 5 and the outer plastic sheath 6 enhance the shielding effect, assuring high signal transmission stability and reliability.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A digital audio video cable comprising an electrical strand formed of a plurality of high-frequency transmission lines, a plurality of low-frequency transmission wires, a tin foil layer surrounding said electrical strand, a braided layer surrounding said tin foil layer and an outer plastic sheath surrounding said braided layer, wherein each said high-frequency transmission line comprises a plurality of high-frequency transmission wires arranged in parallel, said high-frequency transmission wires being equal in length, an insulation layer surrounding said high-frequency transmission wires, and a grounding wire disposed outside said insulation layer in a parallel manner relative to said high-frequency transmission wires.

2. The digital audio video cable as claimed in claim 1, wherein each said high-frequency transmission wire is formed of a copper covered steel wire.

3. The digital audio video cable as claimed in claim 1, wherein each said high-frequency transmission wire is formed of a silver-coated copper clad steel wire.

4. The digital audio video cable as claimed in claim 1, wherein each said grounding wire is formed of a tinned copper wire.

5. The digital audio video cable as claimed in claim 1, wherein each said grounding wire is formed of a brass wire.

6. The digital audio video cable as claimed in claim 1, wherein each said low-frequency transmission wire is formed of a tinned copper wire.

7. The digital audio video cable as claimed in claim 1, wherein each said low-frequency transmission wire is formed of a brass wire.

8. The digital audio video cable as claimed in claim 1, wherein said insulation layer is formed of a thermoplastic elastomer composition.

9. The digital audio video cable as claimed in claim 1, wherein said insulation layer is formed of polyethylene.

10. The digital audio video cable as claimed in claim 1, wherein each said high-frequency transmission line further comprises two shielding layers surrounding said insulation layer, and the grounding wire of each said high-frequency transmission line is set in between the two shielding layers of the respective high-frequency transmission line in a middle position relative to the associating high-frequency transmission wires.

11. The digital audio video cable as claimed in claim 10, wherein each said shielding layer is a mylar film made of polyethylene terephthalate polyester.

12. The digital audio video cable as claimed in claim 1, wherein said braided layer is a tubular braid of brass wires.

13. The digital audio video cable as claimed in claim 1, wherein said braided layer is a tubular braid of silver-plated wires.

14. The digital audio video cable as claimed in claim 1, wherein said outer plastic sheath is formed of polyvinyl chloride.

15. The digital audio video cable as claimed in claim 1, wherein said outer plastic sheath is formed of polyethylene.

16. The digital audio video cable as claimed in claim 1, wherein said outer plastic sheath is formed of polyethylene terephthalate.

17. The digital audio video cable as claimed in claim 1, wherein said outer plastic sheath is formed of polypropylene.
